(19) United States
(12) Patent Application Publication
(10) Pub. No.: US 2021/0256782 A1
(43) Pub. Date: Aug. 19, 2021

(54) COMMERCIAL VEHICLE ON-BOARD ABNORMAL VIBRATION ANALYSIS AND DETECTION

(71) Applicant: International Truck Intellectual Property Company, LLC, Lisle, IL (US)

(72) Inventor: Mark S. Ehlers, Fort Wayne, IN (US)

(73) Assignee: International Truck Intellectual Property Company, LLC, Lisle, IL (US)

(21) Appl. No.: 16/791,284

(22) Filed: Feb. 14, 2020

(51) Int. Cl. G07C 5/08; H04W 4/40; G07C 5/00; G06Q 10/00; G06Q 10/08

(52) U.S. Cl. CPC G07C 5/0808; H04W 4/40; G06Q 10/0875; G06Q 10/20; G07C 5/008

(57) ABSTRACT

A system for detecting abnormal vibrations in vehicles utilizes an accelerometer of a vehicle stability control system, anti-lock braking system, traction control system, engine, transmission, SRS and/or air bag, and/or telematics device. The system data logs vibration information produced by the accelerometer, establishes normal vibration signatures for the vehicle, and detects abnormal vibrations. The abnormal vibrations may be reported by the telematics device via a data connection gateway between a vehicle communication bus and a backend server, and/or reported to the driver via a display. The system may report the abnormal vibrations via a phone or web application. The system may establish normal vibration signatures and detect abnormal vibrations based on fixed vehicle specific values and variable vehicle operating conditions. The system may analyze the abnormal vibrations to determine whether they match the vibration signature of a particular out of balance or otherwise faulty vehicle component.

### BACKGROUND

This disclosure relates to an arrangement and method for detecting abnormal vibrations in commercial vehicles, and analyzing the vibrations to identify their source. Particularly, this disclosure relates to an arrangement and method for monitoring one or more accelerometer(s) embedded on the vehicle as part of the vehicle stability control system, transmission control system, anti-lock braking system and/or traction control, Safety Restraint System (SRS) and/or air bag modules, and/or as part of a telematics module, and using such accelerometer(s) to detect and analyze abnormal vibrations.

### RELATED ART

It is known to provide a vehicle stability control system on vehicles such as cars and commercial vehicles. Such systems improve vehicle stability, for example by selectively applying individual wheel brakes to create a restorative yaw moment to correct for understeer or oversteer during transient maneuvers. In order to determine actual vehicle motion in comparison to driver commanded inputs, vehicle stability control systems are provided with a three axis accelerometer. Other vehicle subsystems are also known to include accelerometers in order to improve performance. For example, it is known to implement an accelerometer in a transmission control module of an automatic or automated manual transmission, in order to improve shift tuning by way of adaptive logic implemented in the engine and/or transmission. Similarly, it is known to implement an accelerometer in an anti-lock braking system and/or traction control. Similarly, vehicle telematics devices are known to include an accelerometer for crash detection purposes, or to identify aggressive drivers. Such accelerometers used in vehicle subsystems, stability control systems, anti-lock braking system and/or traction control, and/or telematics devices are known to include two and three axis accelerometers.

It is long known to address vehicle vibration problems using a trial and error approach. Specifically, mechanics often test drive vehicles in order to ascertain by feel whether a vibration is originating from the vehicle wheels, drivetrain, or engine. Sometimes, vehicle components such as wheels or driveshafts are removed from the vehicle and tested separately to determine if there is an imbalance. In this case, special tools and instruments are utilized to determine the existence of an imbalance or other vibration inducing problem. It is more recently known to utilize a handheld tool or laptop based tool having an accelerometer to determine the severity and frequency of abnormal vibrations. Such a handheld tool may be provided with a magnetic base, by way of which the handheld tool is affixed to a source of vibration for the purpose of identifying its source. Such laptop based tool may be provided with a remote portable accelerometer with a magnetic base for the same purpose. It is further known to use a smart phone having a built in accelerometer in this capacity. When a handheld tool, laptop, or smart phone having an accelerometer is used to analyze abnormal vibrations, a data log of the frequency and intensity of the vibrations is generated during a test drive. The data log is then compared to vehicle and component specifications, in order to determine which vehicle components are rotating at speeds that correlate to the abnormal vibrations. These correlations are then used to identify the source of the vibration, which leads to reduced diagnostic time and improved success in repairs.

One problem associated with the use of a handheld or laptop based tool having an accelerometer to determine the severity and frequency of abnormal vibrations is that the handheld or laptop based tool is often not used until the abnormal vibration has developed to the point where it becomes noticeable to the driver. Given that vehicles routinely encounter bumps, noise, and vibration, especially commercial vehicles having stiffer suspensions, this means that the source of the vibration may be well advanced before a diagnosis takes place. Furthermore, successful detection and analysis of vibrations in vehicles tends to be dependent upon placement of the handheld tool, remote portable accelerometer, or smart phone. That is to say, variations in the stiffness and natural frequency of various vehicle components and structures results in greater or lesser transmission of certain frequencies of vibrations. As a result, it may be difficult to achieve an accurate comparison between a given data log of vibrations detected by a handheld or laptop based tool or smart phone, and the potential sources of the vibrations. Furthermore, vibration diagnostics tends to be a specialty of vehicle technicians, who require specialized tool and training. These tools tend to be expensive, and the training tends to be particularly expensive.

It is further known to use an accelerometer installed upon and specifically dedicated to a vehicle component to detect abnormal vibrations in that component alone. For example, it is known to attach an accelerometer to the hub of a vehicle axle, in order to detect imbalances in the wheels, tires, and brakes. However, such devices are limited to the detection of vibrations in the vehicle component to which it is attached, and is unable to detect or analyze vibrations coming from any other component.

Accordingly, there is an unmet need for an arrangement and method for detecting and analyzing abnormal vehicle vibrations deriving from multiple potential vehicle component sources in an accurate and repeatable fashion before such abnormal vehicle vibrations become detectable to the driver.

### SUMMARY

According to one embodiment of the arrangement and method for detecting abnormal vibrations in vehicles, and analyzing the vibrations to identify their source, a vehicle has a system for detecting and analyzing abnormal vibrations. The system includes an accelerometer configured to provide acceleration data to a vehicle stability control system, an anti-lock braking system, a traction control system, a vehicle engine, a vehicle transmission, Safety Restraint System (SRS) and/or air bag modules, and/or a telematics device. The system further includes a device for recording and data logging vibration information produced by the accelerometer. The system further includes a processor configured to establish normal vibration signatures for the vehicle, and to detect abnormal vibrations. The system further includes an arrangement for logging and reporting the abnormal vibrations.

According to another embodiment of the arrangement and method for detecting abnormal vibrations in vehicles, and analyzing the vibrations to identify their source, a system is provided for detecting and analyzing abnormal vibrations in a vehicle. The system includes an accelerometer configured to provide acceleration data to a vehicle stability control system, an anti-lock braking system, a traction control system, a vehicle engine, a vehicle transmission, Safety Restraint System (SRS) and/or air bag modules, and/or a telematics device. The system further includes a device for recording and data logging vibration information produced by the accelerometer. The system further includes a processor configured to establish normal vibration signatures for the vehicle, and to detect abnormal vibrations. The system further includes an arrangement for logging and reporting the abnormal vibrations.

According to another embodiment of the arrangement and method for detecting abnormal vibrations in vehicles, and analyzing the vibrations to identify their source, a method of detecting and analyzing abnormal vibrations in a vehicle includes several steps. The first step is configuring a telematics device having an accelerometer to recording and data log vibration information produced by the accelerometer. The second step is configuring a processor of the telematics device to establish normal vibration signatures for the vehicle, and to detect abnormal vibrations. The third step is configuring the telematics device to log the abnormal vibrations. The fourth step is configuring the telematics device to provide a data connection gateway between a vehicle communication bus, a backend server, and at least one vehicle component. The fifth step is configuring the telematics device to report the abnormal vibrations by way of at least one of a phone application and a web application.

### DESCRIPTION OF THE DRAWINGS

FIG. 1 is a block diagram of an embodiment of a telematics device according to the present disclosure, as described herein;

FIG. 2 is a diagram of an embodiment of a communication system used with a telematics device according to the present disclosure, as described herein;

FIG. 3 is a software architecture reference diagram of a telematics device according to the present disclosure, as described herein;

FIG. 4 is a data acquisition (DAQ) app use case diagram of a telematics device according to the present disclosure, as described herein; and

FIG. 5 is a Universal Analog/Digital Input Circuit Diagram of an embodiment of a telematics device according to the present disclosure, as described herein.

### DETAILED DESCRIPTION

Embodiments described herein relate to an arrangement and method for detecting abnormal vibrations in vehicles, and analyzing the vibrations to identify their source. The arrangement and method may be applied to various types of passenger vehicles, commercial vehicles, and recreational vehicles, such as highway or semi-tractors with and without auxiliary power units (APUs), straight trucks with and without APUs, buses, fire trucks, agricultural vehicles, construction vehicles, recreational vehicles, campers, motorhomes, motorcycles, scooters, rail travelling vehicles, and trailers with and without APUs or refrigeration units. Hereinafter, the term vehicle is to be construed as including trailers. It is further contemplated that embodiments of the arrangement and method may be applied to vehicles having engines configured for various fuels, such as gasoline, diesel, propane, natural gas, and hydrogen, as non-limiting examples. It is further contemplated that embodiments of the arrangement and method may be applied to vehicles having hybrid and full electric drive.

The arrangement and method for detecting abnormal vibrations in vehicles, and analyzing the vibrations to identify their source, uses certain sensor(s) and their data output that may be present on certain commercial vehicles. Specifically, the arrangement and method may use an accelerometer that provides data for a vehicle stability control system, an accelerometer that provides data for an anti-lock braking system and/or traction control, an accelerometer that provides data to optimize shifting in a vehicle transmission, an accelerometer used in a Safety Restraint System (SRS) and/or in airbag modules, an accelerometer that is present in some telematics modules, and/or other engine or body mounted accelerometer. In order to do so, the accelerometer of the vehicle stability control system, the accelerometer of the anti-lock braking system and/or traction control, the accelerometer of the vehicle transmission, the accelerometer of the Safety Restraint System (SRS) and/or airbag modules, the accelerometer of the telematics module, and/or other engine or body mounted accelerometer may be calibrated to provide data in the range of potential abnormal vibrations in vehicles, in addition to providing data in the ranges necessary to their primary functions.

For non-limiting example, a bolt-in telematics device is provided with a built in or embedded accelerometer. The telematics device is designed to provide a data connection gateway between a vehicle communication bus, a backend server, and onboard devices. The telematics device may be intended to be used, for non-limiting example, in commercial vehicle applications, and is capable of operation in a vehicle cab having a −40° C. to 85° C. environment, and remains operable during normal operating voltage conditions. The telematics device assembly in some embodiments weighs no more than one pound and may be provided with a means to attach the telematics device to a flat surface. The size of the telematics device housing may, in some embodiments, be no larger than 3.75″ in width, 1.2″ in height, and 5″ in length. Corrosion resistant fasteners may be used on the housing. In some embodiments, no special tools are required for installing the device.

The telematics device pertains to FMVSS 101 “Controls, Telltales, and Indicators,” FMVSS 302 “Flammability of Interior Material,” CMVSS 101 “Location and Identification of Controls and Displays,” CMVSS 302 “Flammability of Interior Material,” and 47 CFR Part 2 “Title 47 Telecommunication,” all of which are hereby incorporated by reference in their entirety. The telematics device further pertains to SAE J1939-11 “Physical Layer, 250 Kbps, Twisted Shielded Pair,” SAE J1939-14 “Physical Layer, 500 Kbps,” SAE J1939-15 “Reduced Physical Layer, 250K bits/sec, Un-Shielded Twisted Pair (UTP),” SAE J1939-21 “Data Link Layer,” SAE J1939-31 “Network Layer,” SAE J1939-71 “Vehicle Application Layer,” SAE J1939-73 “Application Layer—Diagnostics,” SAE J1939-81 “Network Management,” SAE J1939-82 “Compliance—Truck and Bus,” SAE J1939DA “J1939 Digital Annex,” IPC 2221A “Generic Standard on Printed Board Design,” ISO 20653 “Road vehicles—Degrees of protection (IP-Code)—Protection of electrical equipment against foreign objects, water and access,” ISO 14229-01 “Unified Diagnostic Services—Specifications and Requirements,” ISO 14229-03 “Unified Diagnostic Services—UDS on CAN implementation,” SAE J1708 “Serial communication between ECUs—heavy duty vehicles,” and IEEE 802.ac “Wireless local area network,” all of which are hereby incorporated by reference in their entirety.

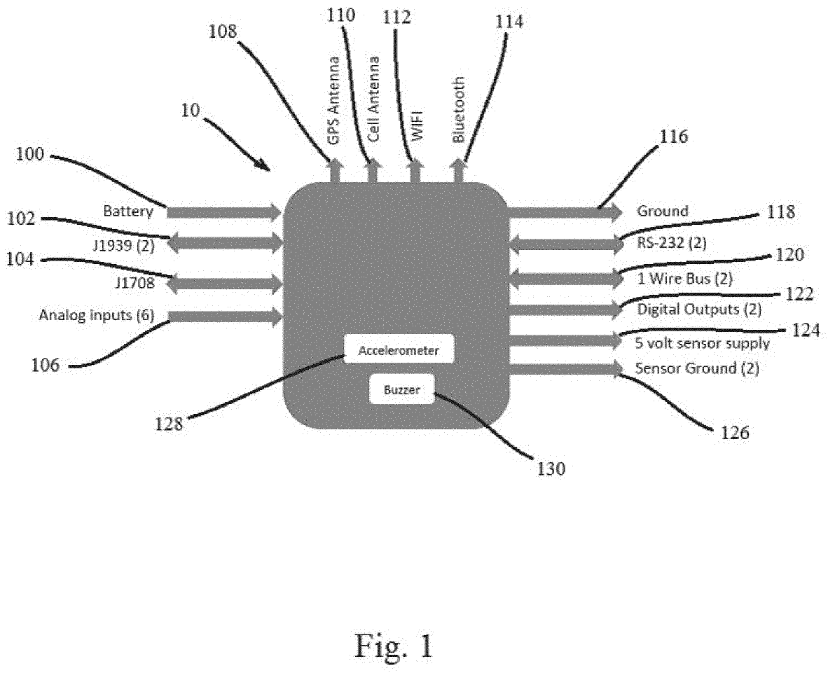

Turning now to FIGS. 1 through 4, a block diagram of the telematics device 10 is presented in FIG. 1. An exemplary embodiment of the telematics device 10 is provided with a battery connection 100, two J1939 connections 102, a J1708 connection 104, and six analog inputs 106. The telematics device 10 is further provided with a GPS antenna connection 108, a cellular antenna connection 110, a Wi-Fi connection 112, and a Bluetooth connection 114. The telematics device 10 is further provided with a ground connection 116, two RS-232 connections 118, two single wire buss connections 120, two digital outputs 122, a five volt sensor supply connection 124, and two sensor grounds 126. The telematics device 10 is further provided with an accelerometer 128 and a buzzer 130.

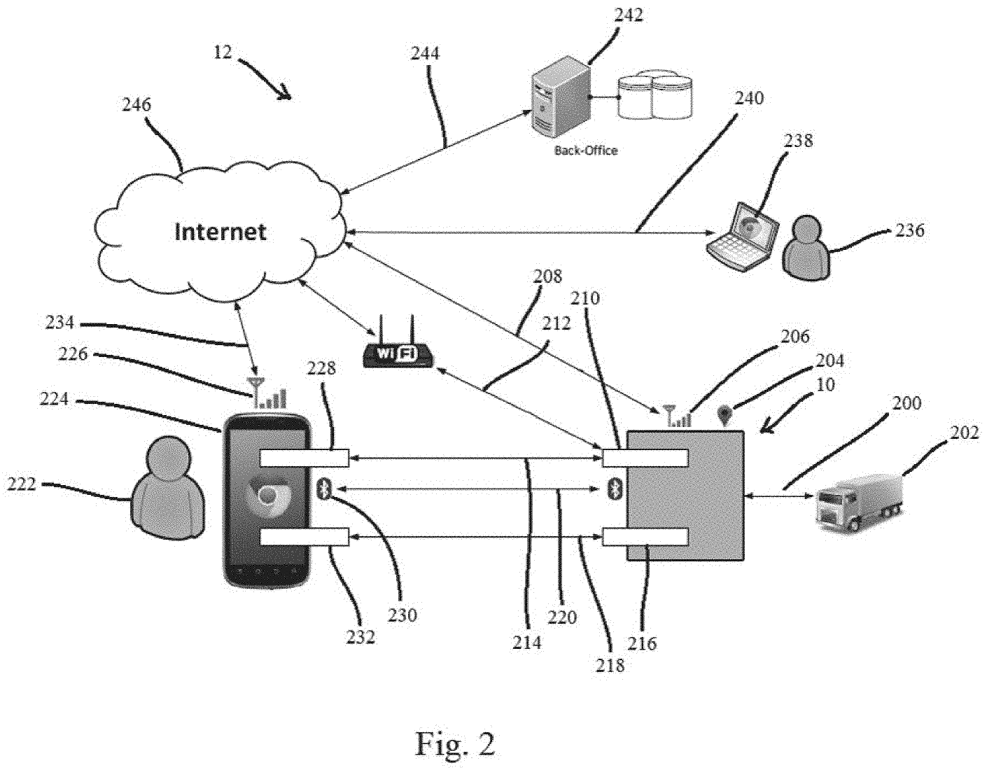

A diagram of an exemplary embodiment of the communication system 12 with which the telematics device 10 is used is presented in FIG. 2. The telematics device 10 runs certain service tool features, runs an application server and/or web server, thereby exposing service tool features and vehicle data to the User Interface (UI), and accesses the internet when needed. The telematics device 10 is provided with a J1939 connection 200, by way of which it communicates with the vehicle 202. The telematics device 10 may further be provided with GPS 204 and/or a cellular connection 206. The cellular connection 206 may connect to the internet 246 by way of an LTE or 3G connection 208. The telematics device 10 may be provided with a Wi-Fi client 210, by way of which it may connect to a wireless access point (AP) through a fixed hotspot connection 212.

The telematics device 10 may further be provided with a Wi-Fi access point 216. The telematics device 10 may then connect to the Wi-Fi access point 228 of a cell phone 224 of a local user 222 by way of the Wi-Fi client 210 of the telematics device 10 and cellphone hotspot connection 214. The cell phone 224 then connects to the Wi-Fi access point 216 of the telematics device 10 by way of the Wi-Fi client 232 of the cell phone 224 and mobile app connection 218. In this way, the cell phone 224 may run a mobile app UI and may provide internet access by way of cellular connection 226 and LTE or 3G connection 234 if needed. The mobile app connection 218 then provides a link to access service tool features and vehicle data, and to configure the link as a Wi-Fi client, or to setup applications that the link can use for internet purposes. Bluetooth connections 220 and 230 may be provided, and may function in a similar way. A remote user 236 is able to access service tool features and vehicle data (HTTP/IP) from the telematics device 10 by way of a web application UI 238 and web application link 240. Further communications can take place between the telematics device 10 and a back-office server 242 by way of a back-office server link 244.

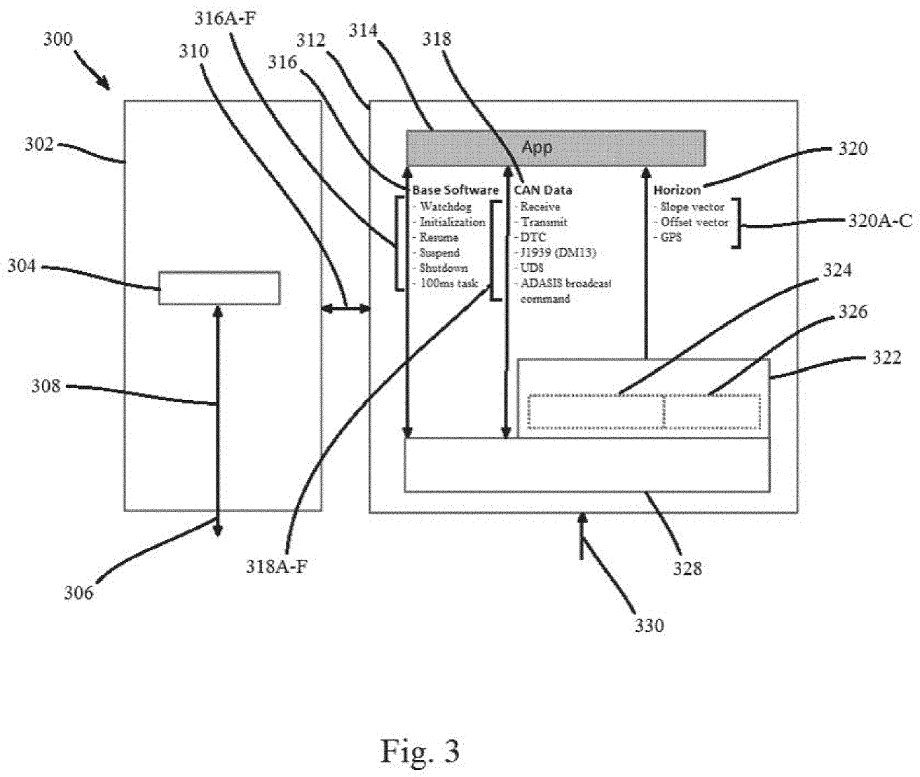

Turning now to FIG. 3, a software architecture reference diagram 300 is presented wherein a run time (RT) partition 302 includes an RT base operating system (OS) 304 connected to a CAN bus 306 by way of a CAN stack configuration 308. The RT partition 302 is connected to a main controller 312 by way of an Inter-process communication (IPC) 310. The main controller 312 has Linux base OS 328 running an application 314. The application 314 implements routines such as, for non-limiting example, watchdog 316A, initialization 316B, resume 316C, suspend 316D, shutdown 316E and 100 ms tasks 316F by way of base software 316. The application 314 further implements routines such as, for non-limiting example, receive 318A, transmit 318B, Diagnostic Trouble Code (DTC) 318C, J1939 (DM13) 318D, Unified Diagnostic Service (UDS) 318E, and ADASIS broadcast command 318F using CAN data 318. The Linux base OS 328 may further implement an eHorizon wrapper 322 running an eHorizon app 324 including map data 326. The eHorizon wrapper 322 may interact with the application 314 by way of Horizon 320, including a slope vector 320A, an offset vector 320B, and certain GPS 320C information. The main controller 312 may obtain location information from a Global Navigation Satellite System 330 input.

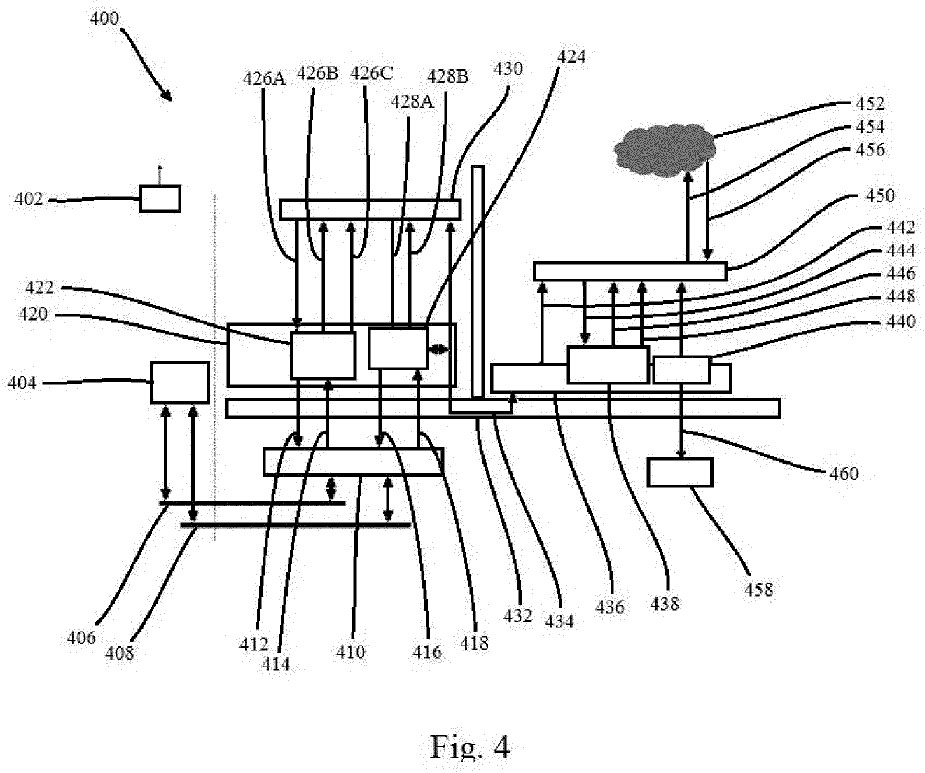

Turning now to FIG. 4, a data acquisition (DAQ) application use case diagram 400 is presented. An electronic control unit (ECU) 404 having a real time clock 402 is connected to a CAN 410 by way of a CAN Calibration Protocol (CCP)/Universal Measurement and Calibration Protocol (XCP) bus 406 and/or a public J1939 bus 408. The real time clock 402 provides real date and timestamps for data samples, and for use by the RT or Linux partition. The CAN 410 communicates with a CCP/XCP Master 422 running in RT Basic Software (BSW) 420 by way of protocol commands (CMD) 412 and command responses (RES) and data acquisition (DAQ) 414. The CAN 410 also communicates with J1939 protocols 424 by way of parameter group number (PGN) register 416 and broadcast and on-request PGNs 418. The CCP/XCP Master 422 then communicates with a DAQ application/RT portion 430 by way of commands or raw CMD CTOs 426A, responses or raw RES CTOs 426B, and/or data samples or raw DAQ CTOs 426C. The J1939 protocols 424 then communicate with the DAQ application/RT portion 430 by way of PGN requests 428A and/or J1939 signals Suspect Parameter Numbers (SPNs) 428B.

The DAQ application/RT portion 430 then communicates with MQ Telemetry Transport (MQTT) 436 by way of Inter Process Communication (IPC) 434 under the supervision of a hypervisor 432. The MQTT 436, in turn, communicates with a DAQ app (Linux portion) 450 by way of J1939 signals 442. A CCP/XCP master 438 of the MQTT 436 also communicates with the DAQ app (Linux portion) 450 by way of configuration or raw CTOs 444, responses or raw RES CTOs 446, and/or XCP DAQ samples 448. A file I/O 440 also communicates with the DAQ app (Linux portion) 450, and may be provided with a data buffer and configurator 460 by which it communicates with an SD card 458. The DAQ app (Linux portion) 450, in turn, may communicate with a back end 452 by way of data offloads 454 and DAQ configurations 456. These may include CCP/XCP measurements, J1939 broadcast SPNs, J1939 on-request SPNs samples, logging rates, and/or event triggered loggings.

The telematics device 10 hardware design may enable all module operating modes to be controlled through software, including a power mode and a sleep mode. The telematics device 10 may be able to enter and exit from sleep mode to allow provisions to minimize power consumption. The sleep mode current consumption by the device may not exceed, for non-limiting example, 3 mA. Sleep mode current is the sum of all electrical currents flowing into the device through all module connections to the vehicle while operating in the sleep mode. Sleep mode current is measured, for non-limiting example, when ignition voltage equals zero volts for five minutes with quiescent current measured from minutes three to five. Sleep mode current is measured once the software controls have placed the module in a sleep state. The telematics device 10 may be able to restore from sleep mode in, for non-limiting example, less than five seconds. The telematics device's CAN controller does not transmit messages onto the J1939 bus while in the Sleep mode. The telematics device's CAN controller may be capable of receiving messages from the J1939 bus while in the Sleep mode. In full power mode, the telematics device is fully operational. The telematics device 10 is capable of waking up to full power mode when J1939 Data Link messages are present and/or when data is received from the cellular interface based on Wake on SMS.

The telematics device 10 has a cellular modem and may support cellular communication systems on GSM (Global Systems for Mobile Communications), UMTS (universal Mobile Telecommunications system) and/or LTE (Long-Term Evolution) standards. The telematics device 10 may be based on eSim Technology with dual-sim. The telematics device 10 supports 3G and 4G (LTE) cellular technologies. The modem may support Evolved High-Speed Packet Access (HSPA+) communications and Short Message Service (SMS) communications on all cellular interfaces. The telematics device 10 may support communications to back-end server systems using TCP/IP v4 Protocol. The telematics device 10 may utilize a self-contained antenna for the cellular interface. A connection to an external antenna may be provided as an option. The telematics device 10 may have an indicator visible to the driver for cellular strength.

The telematics device 10 may support Bluetooth Core Specification 4.1 or newer, and may have an indicator visible to the driver when the Bluetooth connection is established. The telematics device 10 may further support Wi-Fi connectivity, including IEEE 802.11b, IEEE 802.11g, IEEE 802.11n and IEEE 802.11ac wireless networking standards. The telematics device 10 may utilize a self-contained antenna. The telematics device 10 may support WPA2 security protocols, and may support Access Point mode to allow wireless clients (Laptop, mobile phones, desktops etc.) to communicate with the telematics device 10. The telematics device 10 may also supports Wireless Client mode to allow it to connect to another Access point. The telematics device 10 may be able to sustain connections to its wireless clients if its connection to an Access point (wireless client mode) is broken and vice versa. The telematics device 10 may further be able to maintain all wireless connections at all times unless it is powered off or connection is broken by software or physical channel error.

The telematics device 10 may include Global Positioning system (GPS) and/or GLONASS Satellite navigation systems. The telematics device 10 may have a tracking accuracy within, for non-limiting example, three meters and a timing accuracy of, for non-limiting example, less than one second. The telematics device 10 may use NMEA as a communication protocol for GPS related information, and may be able to obtain a first fix within, for non-limiting example, two minutes after being powered on when placed under the vehicle's dashboard. The GPS chip may utilize a self-contained antenna, with an external antenna connection being provided as an option. The telematics device may have an indicator visible to the driver to inform the driver that a GPS fix has been obtained.

The telematics device 10 may utilize a buffer to store minor data writes (i.e.—a buffer on a microprocessor or a separate memory component) to minimize the number of write cycles of the non-volatile memory (NVM), and may be capable of writing flash memory pages for speed purposes. The telematics device 10 may write all data into non-volatile flash memory during scheduled time periods. The telematics device 10 may have a minimum of, for non-limiting example, eight gigabytes of non-removable non-volatile flash memory. The NVM area may be capable of storing data for a minimum of, for non-limiting example, fifteen (15) years without modification, and may be capable of, for non-limiting example, 100,000 write cycles without performance degradation. The NVM may be permanently affixed to the printed circuit board (PCB). The telematics device 10 may further have, for non-limiting example, at minimum one gigabyte of random access memory (RAM), and may be designed to package a total of, for non-limiting example, two gigabytes of RAM.

The telematics device 10 may have an integrated Real Time clock (RTC) chip, which may be synced with GPS time anytime it is available. The telematics device 10 may be able to keep time for years, months, days, hours, minutes, and seconds. The telematics device 10 may not, however, transmit time of day on the J1939 data link. The telematics device 10 may have a software controlled beeper for audible notifications, having a frequency of 2 KHz+100 Hz, for non-limiting example, and a decibel volume of at least 75 dbA at a distance of one meter. The telematics device 10 may further have a Hardware Security Module (HSM) to store certificates, device identities, and keys. The HSM works with Microsoft Azure IoT services.

The telematics device 10 contains a three axis accelerometer 128 that may be software selectable between, for non-limiting example, two, four, and eight g's. The telematics device 10 may have a minimum Linux v4.1 as its operating system, which may support Java Runtime Environment. GPS chip drivers may be embedded in the device, along with BT stack with the required Bluetooth profiles. The telematics device 10 may provide access to real time operation software (non-Linux), and may have the ability to modify its application programming interface (API). The telematics device 10 may contain a completely functional boot loader, kernel software, and vehicle specific application software that is placed in the module's flash memory during manufacture of the module. The telematics device 10 firmware and Operating System may be updateable over-the-air by way of the cellular interface.

The telematics device 10 may function on a 12V or a 24V vehicle electrical system, for non-limiting example, and may perform all specified functions within specification and without degradation of performance from 9.0 to 36.0 volts. The telematics device 10 may tolerate power supply voltages between (−) 28.4 volts (in the case of an accidentally reversed battery installation) to 50.4 volts (in the case of an incorrectly applied jump start of the vehicle). The telematics device 10 may be able to self-recover within two seconds from a temporary abnormal voltage level (i.e.—from (−) 28.4 volts to 9.0 volts, and from 36.0 volts to 50.4 volts) without operator intervention, and experience no permanent damage, although the device may not be required to function normally during an abnormal voltage level.

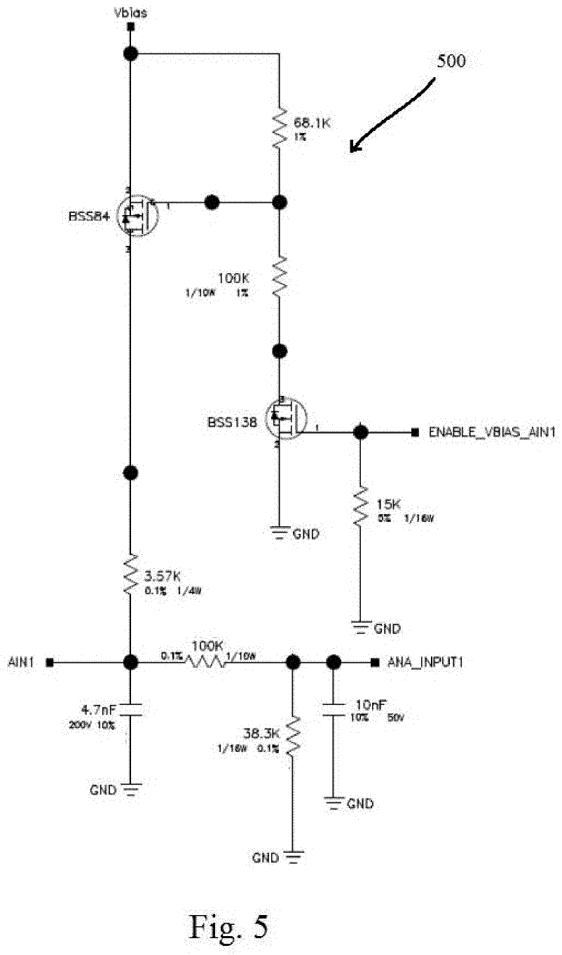

The telematics device 10 may support, for non-limiting example, six analog inputs that can also be used to sense the logic level of a digital input. A Universal Analog/Digital Input Circuit Diagram 500 is shown in FIG. 05. Each analog input may support an input range of 0 to 18 VDC, and have a software selectable pull up resistor of 3.57K Ohms+/−0.1%. The pull up resistor may be connected to a protected battery voltage supply internal to the telematics device 10. Each analog input may be tied to an Analog to Digital converter, and may support a minimum sampling interval of ten times per second with a minimum ten bit precision. The input impedance of each input may be 138K Ohms+/−0.1% when the pull up resistor is disabled by software control.

To power external sensors, the telematics device 10 may support, for non-limiting example, a regulated 5V DC output with a maximum load current of 100 mA. The 5-volt output may be short circuit protected against shorts to ground or battery voltage, such that no physical damage occurs to the telematics device 10. The telematics device 10 may have diagnostic capability on the output to detect short to ground, short to battery, and open circuit. The telematics device 10 may further support two digital outputs, each providing an active high, 12V or 24 volt DC (Vehicle Battery Voltage) output. Output voltage may be equal to battery voltage +0/−0.5 volts under any range of load that is 0.5 amp or less measured with 14.0 volts for a battery supply. Each output may support up to 500 mA output current, and has a 1K Ohm resistor connected between the output and ground to eliminate leakage current from the output. Each output may be protected against shorts to battery and ground, such that no physical damage occurs to the telematics device 10 during a short. The telematics device 10 may have diagnostic capability on the output to detect short to ground when the output is ON and short to battery when the output is OFF.

The microprocessor of the telematics device 10 may monitor battery voltage as well as all internally regulated power supplies. The telematics device 10 may provide a single core microprocessor as the standard product, and may be designed to package a dual core microprocessor as an option. The telematics device 10 may provide watchdog functionality through a device external to the microcontroller. The watchdog functionality may force the microcontroller to a reset state if the operating program fails to keep the watchdog maintained in an inactive state. The watchdog functionality may be disabled when the telematics device 10 is in the sleep state.

The telematics device 10 may support the SAE J1939 Communication Protocol, and have a configurable baud rate of, for non-limiting example, 500 kB/s or 250 kB/s. The telematics device 10 may auto-detect the baud rate of the J1939 datalink of the vehicle. The telematics device 10 may provide two CAN 2.0B hardware interfaces that meet the requirements of SAE J1939-14. The telematics device 10 may further support SAE J1708 Communication protocol, and provide an SAE J1708 hardware interface. The telematics device 10 may support two RS-232 channels, each being three wires (RX, TX and GND) with no hardware flow control. Each channel may have software (Xon/Xoff) flow control, may support baud rates up to 115 Kbps, and have three Pins. The telematics device 10 may support two 1-Wire serial bus interfaces, and serve as the master on the one wire bus. The one wire interface may meet the requirements of Dallas Semiconductor 1 wire interface. The telematics device 10 may support OBDII connectivity over the CAN bus, and may not support any other OBDII transport mechanism. The telematics device 10 may further support one single wire CAN interface. The interface may be on a dedicated pin that is multiplexed with the secondary CAN bus.

The telematics device 10 may support two connectors, each connector being an automotive grade connector that supports an IP54 rating. The connectors may employ secondary locks for the wires as well as connector position assurance locks for the connector latch. The first of the two connectors may be a vehicle bus connector. The vehicle bus connector may have as its interface a power input (from the vehicle battery), a primary CAN bus, a secondary CAN bus (Supporting J1939 and OBDII), a single wire CAN bus (multiplexed with the secondary CAN), and a J1708/J1857 bus. The second of the two connectors may be an I/O connector. The second connector may have as its I/O six analog inputs, 5 VDC regulated output, two digital outputs, two single wire serial buses, two RS232 channels, and two signal grounds.

The telematics device 10 may incorporate platform software that provides support to certain functionalities. These functionalities may include a hypervisor to manage the software dynamic behavior and virtual partitions, time management and synchronization, telemetry communication protocols such as GSM, WIFI, and etcetera, and module specific device drivers and APIs such as analog input, digital I/O, and Communication links. The functionalities may further include a secure communication to backend servers, a supervisor to monitor device states and/or health, memory management, USB, Bluetooth, system logging capability, secure software update capability, and secure boot capability. The platform software may support Over-the-Air (OTA) software updates, which allow individual application or complete partition updates. The platform software may provide secure device software update mechanisms preventing unauthorized software updates, reverse engineering, and etcetera. The module may provide a secure boot, ensuring trusted software operation only. The platform software of the telematics device 10 may support Bluetooth Core Specification 4.1 or newer.

The hypervisor may provide the foundation for dynamic behavior of the software applications. It may manage the scheduling of processes and events, the data exchange and synchronization between different processes, and provide features for monitoring and error handling. The OS may support the hard real time scheduling for time critical aspect of the embedded system such as CAN communication. In an embodiment wherein Hypervisor is utilized, it may support hard real time virtualization, Linux virtualization, and inter-partition communication. With regards to real time partition specifics, the COM stack may utilize typical J1939 and UDS implementation such as Vector CANbedded J1939 stack or similar. With regards to post build configuration, the real time partition may support configuration updates [OTA] from the Linux partition adding receive signals post build. Transmit signals configuration may not be modifiable post build due to cyber security concerns.

With regards to raw CAN network receive data available to APP layer/Linux IPC, such raw CAN network data may be made available for logging by a Linux partition application. The diagnostic stack may be a typical commercial vehicle stack. An AUTOSAR DEM or similar may be provided as a diagnostic event manager (“DTC manager”). An AUTOSAR J1939 DCM or similar supporting DM1, DM2, DM3, and DM11 functionality may be provided as a diagnostic communication manager (“J1939/UDS server”). The platform software share may provide Non-Volatile Memory (NVM) for application software to save information over ignition cycles. The real time partition may provide an AUTOSAR or OSEK type RTOS, or similar. SDK may provide, for non-limiting example, real time application development, build, install and debug capability, compilers, libraries, and/or debugger interfaces.

With regards to Linux partition(s) specifics, Linux partitions supply a Linux [4.1] OS and a Java virtual machine, for non-limiting example, Java1.8. A Software Development Kit (SDK) provides the capability to independently develop Linux/Java and C++ Apps, including build, install, and debug capability. With regards to data acquisition (DAQ) specific support, the base software provides remote tool clients for XCP/CCP and J1939 protocols. A J1939 “remote scan tool client” is provided wherein base software supports flexible CAN Network message reception for remote tool client and data acquisition purposes. The “J1939 client” supports PGN requests for any PGN, even PGNs not configured in the RIO CAN stack. However, all PGN request responses are received. For non-limiting example, if a new proprietary PGN is added to the network, but is not in the RIO CAN stack configuration, the proprietary PGN can be requested, and the response will be available for data logging. The “J1939” client is able to log data from newly defined CAN messages not defined during the RIO CAN Stack configuration. These messages are receiving only.

Under the DAQ specific support, RAW CAN traffic may be made available for data logging. The DAQ application may record all raw CAN traffic under certain circumstances. For non-limiting example, the DAQ will buffer and then record all raw CAN traffic for a certain period before and after a triggering event. A XCP/CCP “master/remote MCD tool client” may be provided that supports XCP DAQ list configuration and reception, and XCP UPLOAD commands for data polling. The XCP/CCP Master supports Seed & Key unlocking if required by a slave device. The XCP/CCP Master supports measurement (DAQ) and memory UPLOAD functionality only, and may not support any functionality that modifies external controller operation. Further, it may not support XCP/CCP STIM or BYP functionality, XCP/CCP Calibration functionality, or XCP/CCP Flash Programming functionality.

The telematics device 10 may supports J1939 messaging and system requirements as defined in J1939-73, J1939-71, and J1939-21, which are hereby incorporated by reference in their entirety. With regards to Diagnostic Messaging Support, all modules contained in the telematics device 10 may support the J1939 diagnostic messages shown in the following table:

| Diagnostic | | Non-HD OBD |
|---|---|---|
| Message | Description | Modules |
| DM1 | Active Diagnostic Trouble Codes | Required (Modules |
| | (DTCs) | shall send MIL as NA) |
| DM2 | Previously Active | Required |
| | Trouble Codes (DTCs) | |
| DM3 | Diagnostic Data Clear/Reset for | Required |
| | Previously Active DTCs | |
| DM11 | Diagnostic Data Clear/Reset for | Required |
| | Active DTCs | |
| DM13 | Stop Start Broadcast | Required |
| Diagnostic | Description | Non-HD OBD |
| Message | | Modules |

DM1, DM2, DM3 and DM11 interact and control the RT Partition DTC Manager.

Modules contained within the telematics device 10 may provide a Failure Mode Identifier (FMI) value for all faults generated by the module as defined by SAE J1939-73. FMI 3 may be used for any short to source (5V, 12V, or 24V) failure. FMI 4 may be used for any short to ground failure. FMI 5 may be used for any open circuit failure. FMI 0, 1, and 15 through 18 may not be used. Such modules may not permit the initial connection of a service tool to any network it is communicating on to alter its current operating mode. Additional steps may be required to enter any type of non-normal operation such as a diagnostic mode or programming mode. In this way, a service tool may be allowed to passively monitor current operating conditions of a vehicle. Modules contained within the telematics device 10 may set a DM1 fault against the source address of an expected periodic message for any expected periodic message not received for at least five but no more than ten message periods or fifteen minutes, whichever is shorter. This includes normal operation only. For conditions like a load shed event, certain modules may be off and not broadcasting, and those that are still active may know that the load shed event is occurring and therefore will consider that a periodic message is not expected.

With regards to the J1939 Physical Layer, an individual network segment employed by the telematics device 10 may have, for non-limiting example, no more than thirty modules total in a single vehicle configuration. A discrete source address may only be used by one module on an individual vehicle for a primary standard network. This does not apply to the source address used by a bridge module of the telematics device 10 when rebroadcasting a message, or to modules on a subnet of the primary network. An individual network segment's module content will ensure bus loading of less than 60% under nominal conditions, and less than 80% under transient worst-case conditions. A non-limiting example of a transient worst-case condition may be an ABS event. Modules of the telematics device 10 may be Type I, as defined by SAE J1939-11, for connection to standard networks, meaning that termination resistors are not permitted inside of the modules on standard networks.

The telematics device 10 may be compatible with a 125 kbps standard network that complies with SAE J1939-15 except as noted below. The wiring for this style of network may be constructed with individual wires constructed as a twisted pair instead of the jacketed un-shielded twisted pair defined in SAE J1939-15. The telematics device 10 may further be compatible with a 250 kbps standard network that complies with SAE J1939-11 for network segments having 30 modules or less. The telematics device 10 may further be compatible with a 500 kbps standard networks having wiring and topology to comply with SAE J1939-14. Modules of the telematics device 10 may be Type I or Type II, as defined by SAE J1939-11, for connection to proprietary networks, meaning that termination resistors are permitted inside of the modules on proprietary networks.

A vehicle using the telematics device 10 may have a primary diagnostic connector located in the driver's environment that meets ER ERGO-33. For vehicles with OBD devices on a 250 kbps public link, the diagnostic connector may be a Type 1 connector as defined by SAE J1939-13. For vehicles with OBD devices on a 500 kbps public link, the diagnostic connector may be a Type 2 connector as defined by SAE J1939-13. The vehicle may have additional secondary diagnostic connectors as required. These may be used for the OBD network, other standard networks, or proprietary networks as needed. The vehicle may not have a secondary SAE J1939-13 diagnostic connector located in the driver's environment.

Modules of the telematics device 10 intended for standard networks may support the following J1939 messages as outlined in SAE J1939DA (incorporated herein in its entirety): ECU ID (PGN 64965), Software ID (PGN 65242), and Component ID (65259). The following table outlines clarifications to messaging requirements outlined in J1939DA:

| PGN/SPN | Clarification |
|---|---|
| PGN 61444 Electronic | J1939DA lists the Transmission Rate as “engine |
| Engine | speed dependent”; this PGN will have a |
| Controller 1 (EEC1) | periodic transmission rate of 15 ± 6 ms. |

Modules of the telematics device 10 capable of sleep may enter sleep upon receipt of PGN 0d65528 with the “Vehicle Sleep Mode” value of 0x1. Upon the vehicle entering “Vehicle Sleep Mode”, all modules of the telematics device 10 may stop recording faults for loss of data on the vehicle bus. Upon receipt of a PGN 65528 message from the body controller (SA 0x21/0d33) with a “Vehicle Sleep Mode” value of 0x0, the telematics device 10 may resume operations. All modules of the telematics device 10 may wait a minimum of, for non-limiting example, 500 ms before recording loss of data faults on the vehicle bus upon resumption of network operations. All modules of the telematics device 10 may successfully claim all source addresses they wish to use for transmitting messages. Modules of the telematics device 10 may not transmit messages until a successful claim of the source address it wishes to use has been completed per J1939-81 section 4.5, which is incorporated herein in its entirety. Modules of the telematics device 10 may not attempt to claim or transmit messages using the NULL (0d254, 0xFE) or Global (0d255, 0xFF) addresses as their source address. A module of the telematics device 10 may use the NULL (0d254, 0xFE) address only when transmitting a “cannot claim address” message to the bus as outlined in J1939-81 section 4.5.8.3, which is incorporated herein in its entirety. Modules of the telematics device 10 that do not auto-configure their bus speed may begin the address claim process within, for non-limiting example, 150 ms of the application of power. Modules of the telematics device 10 that do auto-configure their bus speed may begin the address claim process within, for non-limiting example, 450 ms of the application of power. Modules of the telematics device 10 intended for standard networks may use certain NAME values. With regards to Unified Diagnostics Services (VSR-UDS), any UDS module of the telematics device 10 may comply with ISO 14229 (Road Vehicles—Unified Diagnostic Services (UDS)), which is hereby incorporated in its entirety.

The telematics device 10 may use state of the art cybersecurity technology in its module hardware and software to prevent malicious access to itself or to the vehicle. The telematics device 10 software may comply with CERT-C and MISRA-C 2012 coding standards, which are incorporated herein in their entirety. The telematics device 10 software functions and algorithms are as simple as possible, and may have cyclomatic complexity less than ten. The telematics device 10 software functions may verify their input and check every known property of input data. The ECU software may further prevent buffer overflows and other types of incorrect access to memory.

The telematics device 10 software may avoid data structures that rely on proper termination, for non-limiting example, null-terminated character strings. Alternative programming interfaces may be used that enforce either explicit passing of sizes of objects and/or the attachment of size of objects to the objects themselves. The telematics device 10 software may only use simple data structures having a fixed, known length. Any variable-length and composite data structures may be prefixed with the length of the structure. Input verification may be applied between different software layers wherever possible, including passing data between software layers. Telematics device 10 software may ensure that race conditions do not occur when accessing system resources, and performs integer calculations safely, such as, for non-limiting example, checks for overflows, underflows, sign propagation, and other errors. The telematics device 10 software may resist timing and differential power analysis attacks when performing cryptographic operations, and avoids floating-point arithmetic on security critical data. The telematics device 10 software may not contain multiple copies of the same software libraries.

The telematics device 10 may support a secure boot process, for non-limiting example, it will not boot an image from a software package that has failed the signature checks of its authenticity. The telematics device 10 Real Time Operating System (RTOS) may support supervisor and user level privileges. User level privilege may not have access to critical CPU resources/memory. The telematics device 10 may not provide a system console or interpretive shells, i.e.—software for controlling the telematics device 10 directly by a human operator or by another computer system, in a way that is not defined by the functional specification of the telematics device 10. Production versions of the telematics device 10 may have their test debug ports permanently or conditionally locked using a strong password that is unique for each telematics device 10 module. Debug port pins may not be easily accessible on the telematics device 10 circuit board, and may be scattered on the circuit board.

With regards to cellular communications, the telematics device 10 may be certified with a cellular provider(s) private network. The telematics device 10 may be able to patch and upgrade firmware remotely, and may be able to shut off the service when not in use. With regards to Bluetooth LE, the telematics device 10 may support security mode 1 Level 3 for LE (low energy) devices. The telematics device 10 may support secured pairing, and may be able to configure “undiscoverable” mode so that a button press is required for pairing. The telematics device 10 may be able to authenticate the paired devices before granting access, and may encrypt all communications between devices. The range of the telematics device 10 with respect to Bluetooth may be limited to the perimeter of the vehicle. The telematics device 10 may be able to operate with lowest energy specification. The telematics device 10 may limit pairing to only one device at a time, may be able to disable all services when not in use, and may be able to patch and upgrade firmware over the air.

With respect to Wi-Fi connectivity, the telematics device 10 may have provision to disable its access point when required. WPS disabled and the access point may have a unique WPA2 password per device. The access point may be enabled from sleep/disabled mode only by a user that has physical access to the telematics device 10. Transmission of network traffic may take place only over a private, secure network. The telematics device 10 may have provision to disable the wireless client. With respect to Global Positioning System (GPS), the GPS receiver may use the latest security features available. With respect to the Hardware-Software Interface, inbound traffic may not be allowed to the telematics device 10. Two-way communication may occur, but may be required to be originated by the telematics device 10 so that there are no exposed ports.

With regards to firmware, admin console access may not be provided by the telematics device 10. If a USB port is provided, a secure certificate signing process may be employed by the telematics device 10 to maintain cyber security. Any unused service (ADDP, telnet, SSH, HTTP, SNMP, TCP/UDP Echo) within the telematics device 10 may be disabled. The telematics device 10 may include a factory reset button to reset the telematics device 10, and a provision to boot the telematics device 10 securely. The telematics device 10 may include a provision to turn off all communications to the CAN bus. Any backdoor entry or debug mode may be disabled before release of a production version of the telematics device 10. The telematics device 10 may be provided with a Hardware Security Module (HSM) that supports MicroSoft Azure IoT services. The telematics device 10 may employ state of the art cybersecurity technology in its module hardware and software design for a given cyber-physical vehicle application, in order to prevent malicious access to the ECU of the vehicle. The telematics device 10 may support J1708 and OBDII protocols and may support OBDII connectivity over the CAN bus.

The following references are hereby incorporated by reference in their entirety:
ISO 14229-1:2013, Road vehicles—Unified diagnostic services (UDS)—Part 1: Specification and requirements, 2nd edition, Date 15 Mar. 2013.
ISO 14229-2:2013, Road vehicles—Unified diagnostic services (UDS)—Part 2: Session layer services, 1st edition, Date 15 Feb. 2013.
ISO 14229-3:2013, Road vehicles—Unified diagnostic services (UDS)—Part 3: Unified diagnostic services on CAN implementation (UDSonCAN), 1st corrected edition, Date 15 Jan. 2013.
SAE J1939, Serial Control and Communications Heavy Duty Vehicle Network—Top Level Document, Date August 2013.
SAE J1939-73, Serial Control and Communications Heavy Duty Vehicle Network—Application Layer—Diagnostics, Date July 2013.
SAE J1939-73, Application Layer—Diagnostics, Date 12 May 2017.
SAE J1939DA, J1939 Digital Annex, Date 10 Oct. 2017.
SAE J1939, Serial Control and Communications Heavy Duty Vehicle Network—Top
Level Document, Date 14 Aug. 2013.
SAE J1939-01, On-Highway Equipment Control and Communications Network, Date 12 Jun. 2018.
SAE J1939-03, On Board Diagnostics Implementation Guide, Date 5 Nov. 2015.
SAE J1939-11, Physical Layer, 250 Kbps, Twisted Shielded Pair, Date 6 Dec. 2016.
SAE J1939-13, Off-Board Diagnostic Connector, Date 25 Oct. 2016.
SAE J1939-14, Physical Layer, 500 Kbps, Date 1 Dec. 2016.
SAE J1939-15, Physical Layer, 250 Kbps, Un-Shielded Twisted Pair (UTP), Date 12 Aug. 2015.
SAE J1939-16, Automatic Baud Rate Detection Process, Date 14 Oct. 2015.
SAE J1939-21, Data Link Layer, Date 3 Mar. 2016.
SAE J1939-31, Network Layer, Date 16 Apr. 2014.
SAE J1939-71, Vehicle Application Layer, Date 25 Oct. 2016.
SAE J1939-73, Application Layer—Diagnostics, Date 12 May 2017.
SAE J1939-74, Application—Configurable Messaging, Date 22 Sep. 2015.
SAE J1939-81, Network Management, Date 9 Mar. 2017.
SAE J1939-82, Compliance, Date 4 Jun. 2015.
SAE J1939-84, OBD Communications Compliance Test Cases for Heavy Duty Components and Vehicles, Date 18 Oct. 2017.
SAE J1939DA, J1939 Digital Annex, Date 10 May 2018.
SAE J1708, Serial Data Communications Between Microcomputer Systems in Heavy-Duty Vehicle Applications, Date 13 Sep. 2016 (Stabilized).
SAE J1587, Electronic Data Interchange Between Microcomputer Systems in Heavy-Duty Vehicle Applications, Date 4 Jan. 2013 (Stabilized).

The arrangement and method for detecting abnormal vibrations in vehicles, and analyzing the vibrations to identify their source, uses data recorded and logged from the accelerometer embedded in the telematics device 10, and/or from an accelerometer that provides data for a vehicle stability control system, and/or from an accelerometer that provides data for an anti-lock braking system and/or traction control, and/or from an accelerometer that provides data to optimize shifting in a vehicle transmission, and/or from an accelerometer used in a Safety Restraint System (SRS) and/or in airbag modules, and/or from another engine and/or body mounted accelerometer. This data is measured, recorded, and/or data logged. The accelerometer used may be a three axis accelerometer, or may be multiple two axis accelerometers. The measured, recorded, and/or data logged vibration information is used to establish normal vibration signatures for the vehicle or trailer at various road speeds, and under various conditions. Vibrations indicating possible problems or abnormalities are then logged and reported to service technicians by way of the phone application or web application.

In some embodiments, the arrangement and method simply reports or allows technician access to the vibration data, including frequency, amplitude, timing, and duration, so that the technician may monitor the data stream and compare the abnormal vibration to vehicle speed, transmission gear, engine speed, and/or other rotating or reciprocating components. This allows the technician to dial in on the source of the abnormal vibration and simplifies vehicle or trailer diagnostics without using special vibration monitoring equipment. In other embodiments, the presence of abnormal vibrations triggers a fault indicating a problem with the vehicle. Some of these faults will alert the driver, while others will simply be logged for later analysis. The fault data may then be reset by a technician by way of a service tool, direct onboard access, cell phone access, or remote access. Alternately, the measured, recorded, and/or data logged vibration information may be accessed by the technician upon complaint by the driver.

In other embodiments, the telematics device, or the vehicle or trailer, data logs the accelerometer data, and compares it to normal vibration frequencies and amplitudes, given fixed vehicle specific values such as, for non-limiting example, tire size, transmission ratios, and axle ratios, and under various conditions such as, for non-limiting example, speed, engine RPM, transmission gear selection, acceleration, braking, coasting, and etcetera. If abnormal vibrations are detected, the abnormal vibrations are analyzed to determine if they match the vibration signature of a particular out of balance or otherwise faulty vehicle component. That is to say, when a vehicle component such as a wheel bearing, driveshaft, u-joint, wheel, or tire becomes out of balance, or begins to fail, it generates a signature vibration signal. The arrangement and method for detecting abnormal vibrations in vehicles, and analyzing the vibrations to identify their source, compares the reported abnormal vibrations with known signature vibration signals by way of logic tables, and reports to the local or remote user possible sub-system specific issues. The arrangement and method may even provide warning of a developing dangerous condition, similar to a low tire pressure warning. In some embodiments, the arrangement and method for detecting abnormal vibrations in vehicles, and analyzing the vibrations to identify their source, may monitor and record other vehicle data, such as tire pressure, temperatures, engine throttle setting, and etcetera. The arrangement and method may then factor these variables in when determining the source of the abnormal vibration.

The arrangement and method for detecting abnormal vibrations in vehicles, and analyzing the vibrations to identify their source, is able to compensate for normal road bumps, noise, and vibrations, and is able to determine normal vibrations for a healthy vehicle based on their recurrence and predictability. The arrangement and method is able to establish the level of normal vibrations for a given vehicle despite the subjective nature of what vibrations may be considered normal. This may be accomplished by allowing the operator to adjust the sensitivity of the arrangement and method to abnormal vibrations, thereby avoiding nuisance warnings to the driver. The arrangement and method may further allow setting of different thresholds of abnormal vibrations required to be present to trigger an alert or fault, or to trigger logging the vibrations, according different vehicle vocations. Further, the arrangement and method may set different thresholds according to whether the vehicle or trailer is moving or stationary, or whether certain vehicle or trailer subsystems are active, such as, for non-limiting example, a vehicle auxiliary power unit (APU) or refrigeration unit. Because the accelerometer used by the arrangement and method is in a consistent location in the vehicle, normal and abnormal vibrations are more readily identified. The measured, recorded, and/or data logged vibration information may be reported out to the driver, and/or may be relayed to a back office server. If used with a telematics system, the arrangement and method may be capable of tracking the vehicle, notifying maintenance personnel, and locating repair parts and facilities according to the vehicle components and/or sub-systems likely at fault.

Sources of abnormal vehicle vibrations may include, for non-limiting example:
i. U-joint fault or failure
ii. Wheel bearing fault or failure
iii. Pre-blow-out tire fault or failure, such as an internal belt or tread separation
iv. Wheel securement fault or failure
v. Lost wheel balance weight
vi. CV joint or half shaft fault or failure
vii. Brake drum or brake rotor warp or defect (In this case, abnormal vibrations will be detected during braking events as identified by the telematics module and vehicle datalink)
viii. Other brake system fault or fault
ix. Engine misfire or other engine issue
x. Engine fan, alternator, AC compressor, water pump, or other belt driven device fault or failure
xi. Electric cooling fan or any other motorized accessory fault or failure
xii. Transmission fault or failure
xiii. Driveline angle issue
xiv. Half shaft alignment issue
xv. Driveline out of phase issue
xvi. Driveline carrier bearing fault or failure
xvii. Suspension system fault, failure, or issue
xviii. Rear axle fault, failure, or issue
xix. Mud or snow pack on a wheel or other foreign object on a wheel
xx. Transfer case or similar device fault, failure, or issue
xxi. Power take off fault or failure
xxii. Deterioration of vehicle or trailer vibration damper, isolator, or “mount”
xxiii. Electric driveline fault or failure
xxiv. Electrified vehicle subsystem fault or failure, such as electric steering, electric A/C compressor, electric water pump, and etcetera.
xxv. Change in vehicle aerodynamics due to loose or missing body component, such as, for non-limiting example, air fairings (if damaged, air fairings can create a measurable change in the vehicle's vibration signature)

The arrangement and method for detecting abnormal vibrations in vehicles, and analyzing the vibrations to identify their source, may provide significant safety benefits such as alerting the driver and telematics that the vehicle has an abnormal vibration and may need to be withdrawn from service. The arrangement and method reduces diagnostic time and labor, expense, and down-time. Further, the arrangement and method allows for the detection of vehicle faults and failures before they have progressed significantly, thereby allowing repairs to take place before other components become involved in the failure. The arrangement and method may even provide benefits in the areas of driver coaching and accident detection and reconstruction.

While the arrangement and method for detecting abnormal vibrations in vehicles, and analyzing the vibrations to identify their source, has been described with respect to at least one embodiment, the arrangement and method can be further modified within the spirit and scope of this disclosure, as demonstrated previously. This application is therefore intended to cover any variations, uses, or adaptations of the system and method using its general principles. Further, this application is intended to cover such departures from the present disclosure as come within known or customary practice in the art to which the disclosure pertains and which fall within the limits of the appended claims.

What is claimed is:

1. A vehicle having a system for detecting and analyzing abnormal vibrations, comprising:
an accelerometer configured to provide acceleration data to at least one of a vehicle stability control system, an anti-lock braking system, a traction control system, a vehicle engine, a vehicle transmission, a Safety Restraint System, an airbag module, and a telematics device;
a device for recording and data logging vibration information produced by the accelerometer;
a processor configured to establish normal vibration signatures for the vehicle, and to detect abnormal vibrations; and
an arrangement for logging and reporting the abnormal vibrations.

2. The vehicle of claim 1, wherein:
the accelerometer being integrated with the telematics device;
the telematics device being configured to provide a data connection gateway between a vehicle communication bus, a backend server, and at least one vehicle component; and
the telematics device being configured to report the abnormal vibrations by way of at least one of a phone application and a web application.

3. The vehicle of claim 2, wherein:
the processor being further configured to establish normal vibration signatures and detect abnormal vibrations based on a fixed vehicle specific value comprising at least one of tire size, transmission ratios, and axle ratio; and
the processor being further configured to establish normal vibration signatures and detect abnormal vibrations based on an operating condition comprising at least one of vehicle speed, engine RPM, transmission gear selection, vehicle rate of acceleration, vehicle rate of braking, and a state of coasting.

4. The vehicle of claim 3, wherein:
the processor being further configured to analyze the abnormal vibrations to determine, by way of a logic table, whether they match the vibration signature of a particular out of balance or otherwise faulty vehicle component; and
the telematics device being further configured to report possible vehicle sub-system specific issues.

5. The vehicle of claim 4, wherein:
the logic table further including vehicle data comprising at least one of tire pressure, vehicle component temperature, and engine throttle setting.

6. The vehicle of claim 5, wherein:
the processor being further configured to set different thresholds for the detection of abnormal vibrations depending on at least one of whether the vehicle is moving or stationary, whether vehicle subsystem is active, and vehicle vocation.

7. The vehicle of claim 4, wherein:
the telematics device being further configured to report the development of a dangerous vehicle condition.

8. The vehicle of claim 4, wherein:
the telematics device being further configured to track the vehicle, notify maintenance personnel of the out of balance or otherwise faulty vehicle component, and locate repair parts and facilities according to the vehicle components and/or sub-systems likely at fault.

9. A system for detecting and analyzing abnormal vibrations in a vehicle, comprising:
an accelerometer configured to provide acceleration data to at least one of a vehicle stability control system, an anti-lock braking system, a traction control system, a vehicle engine, a vehicle transmission, a Safety Restraint System, an airbag module, and a telematics device;
a device for recording and data logging vibration information produced by the accelerometer;
a processor configured to establish normal vibration signatures for the vehicle, and to detect abnormal vibrations; and
an arrangement for logging and reporting the abnormal vibrations.

10. The system of claim 9, wherein:
the accelerometer being integrated with the telematics device;
the telematics device being configured to provide a data connection gateway between a vehicle communication bus, a backend server, and at least one vehicle component; and
the telematics device being configured to report the abnormal vibrations by way of at least one of a phone application and a web application.

11. The system of claim 10, wherein:
the processor being further configured to establish normal vibration signatures and detect abnormal vibrations based on a fixed vehicle specific value comprising at least one of tire size, transmission ratios, and axle ratio; and
the processor being further configured to establish normal vibration signatures and detect abnormal vibrations based on an operating condition comprising at least one of vehicle speed, engine RPM, transmission gear selection, vehicle rate of acceleration, vehicle rate of braking, and a state of coasting.

12. The system of claim 11, wherein:
the processor being further configured to analyze the abnormal vibrations to determine, by way of a logic table, whether they match the vibration signature of a particular out of balance or otherwise faulty vehicle component; and
the telematics device being further configured to report possible vehicle sub-system specific issues.

13. The system of claim 12, wherein:
the logic table further including vehicle data comprising at least one of tire pressure, vehicle component temperature, and engine throttle setting.

14. The system of claim 13, wherein:
the processor being further configured to set different thresholds for the detection of abnormal vibrations depending on at least one of whether the vehicle is moving or stationary, whether vehicle subsystem is active, and vehicle vocation.

15. The system of claim 12, wherein:
the telematics device being further configured to report the development of a dangerous vehicle condition.

16. The system of claim 12, wherein:
the telematics device being further configured to track the vehicle, notify maintenance personnel of the out of balance or otherwise faulty vehicle component, and locate repair parts and facilities according to the vehicle components and/or sub-systems likely at fault.

17. A method of detecting and analyzing abnormal vibrations in a vehicle, comprising the steps of:
configuring a telematics device having an accelerometer to recording and data log vibration information produced by the accelerometer;
configuring a processor of the telematics device to establish normal vibration signatures for the vehicle, and to detect abnormal vibrations;
configuring the telematics device to log the abnormal vibrations;
configuring the telematics device to provide a data connection gateway between a vehicle communication bus, a backend server, and at least one vehicle component; and
configuring the telematics device to report the abnormal vibrations by way of at least one of a phone application and a web application.

18. The method of claim 17, further comprising the steps of:
configuring the processor to establish normal vibration signatures and detect abnormal vibrations based on a fixed vehicle specific value comprising at least one of tire size, transmission ratios, and axle ratio; and
configuring the processor to establish normal vibration signatures and detect abnormal vibrations based on an operating condition comprising at least one of vehicle speed, engine RPM, transmission gear selection, vehicle rate of acceleration, vehicle rate of braking, and a state of coasting.

19. The method of claim 18, further comprising the steps of:
configuring the processor to analyze the abnormal vibrations to determine, by way of a logic table, whether they match the vibration signature of a particular out of balance or otherwise faulty vehicle component; and
configuring the telematics device to report possible vehicle sub-system specific issues.

20. The method of claim 19, further comprising the steps of:
configuring the telematics device to track the vehicle, notify maintenance personnel of the out of balance or otherwise faulty vehicle component, and locate repair parts and facilities according to the vehicle components and/or sub-systems likely at fault.
